(19) United States
(12) Patent Application Publication
(10) Pub. No.: US 2008/0133310 A1
(43) Pub. Date: Jun. 5, 2008

(54) METHODS AND SYSTEMS FOR FORECASTING PRODUCT DEMAND FOR SLOW MOVING PRODUCTS

(76) Inventors: Edward Kim, Toronto (CA); Jean-Philippe Vorsanger, Toronto (CA); Stanley Chan, Toronto (CA); Shireengul Islam, Mississauga (CA)

Correspondence Address: JAMES M. STOVER;TERADATA CORPORATION, 2835 MIAMI VILLAGE DRIVE, MIAMISBURG, OH, 45342, US

(21) Appl. No.: 11/565,685

(22) Filed: Dec. 1, 2006

(51) Int. Cl. G06F 17/30

(52) U.S. Cl. 705/10

(57) ABSTRACT

An improved method for forecasting and modeling product demand for a slow moving product. The method includes the steps of maintaining a database of historical product demand information, calculating the average rate of sales (ARS) for a product from the historical demand information corresponding to the product, determining if the product is a slow moving product (SMP), and if the product is a SMP modifying the ARS using a mean reverting forecast method called GARCH (Generalized Autoregressive Conditional Heteroscedasticity) to accurately model the expected demand and variability of the slow moving product.

### CROSS REFERENCE TO RELATED APPLICATIONS

This application is related to the following co-pending and commonly-assigned patent applications, which are incorporated by reference herein:

Application Ser. No. 11/026,273; entitled “METHODS AND SYSTEMS FOR FORECASTING PRODUCT DEMAND FOR PRODUCTS HAVING INTERMITTENT DEMAND;” filed on Dec. 31, 2004 by Edward Kim, J. P. Vorsanger, Blair Bishop, and Frank Luo; attorney's docket number 11,856.

### FIELD OF THE INVENTION

The present invention relates to methods and systems for forecasting product demand for retail operations, and in particular to the forecasting of future product demand for products with sporadic historical demand.

### BACKGROUND OF THE INVENTION

Accurately determining demand forecasts for products are paramount concerns for retail organizations. Demand forecasts are used for inventory control, purchase planning, work force planning, and other planning needs of organizations. Inaccurate demand forecasts can result in shortages of inventory that are needed to meet current demand, which can result in lost sales and revenues for the organizations. Conversely, inventory that exceeds a current demand can adversely impact the profits of an organization. Excessive inventory of perishable goods may lead to a loss for those goods.

Teradata, a division of NCR Corporation, has developed a suite of analytical applications for the retail business, referred to as Teradata Demand Chain Management (DCM), that provides retailers with the tools they need for product demand forecasting, planning and replenishment. Teradata Demand Chain Management assists retailers in accurately forecasting product sales at the store/SKU (Stock Keeping Unit) level to ensure high customer service levels are met, and inventory stock at the store level is optimized and automatically replenished. Teradata DCM helps retailers anticipate increased demand for products and plan for customer promotions by providing the tools to do effective product forecasting through a responsive supply chain.

As illustrated in FIG. 1, the Teradata Demand Chain Management analytical application suite 101 is shown to be part of a data warehouse solution for the retail industries built upon NCR Corporation's Teradata Data Warehouse 103, using a Teradata Retail Logical Data Model (RLDM) 105. The key modules contained within the Teradata Demand Chain Management application suite 101, are:

Contribution: Contribution module 111 provides an automatic categorization of SKUs, merchandise categories and locations based on their contribution to the success of the business. These rankings are used by the replenishment system to ensure the service levels, replenishment rules and space allocation are constantly favoring those items preferred by the customer.

Seasonal Profile: The Seasonal Profile module 112 automatically calculates seasonal selling patterns at all levels of merchandise and location. This module draws on historical sales data to automatically create seasonal models for groups of items with similar seasonal patterns. The model might contain the effects of promotions, markdowns, and items with different seasonal tendencies.

Demand Forecasting: The Demand Forecasting module 113 provides store/SKU level forecasting that responds to unique local customer demand. This module considers both an item's seasonality and its rate of sales (sales trend) to generate an accurate forecast. The module continually compares historical and current demand data and utilizes several methods to determine the best product demand forecast.

Promotions Management: The Promotions Management module 114 automatically calculates the precise additional stock needed to meet demand resulting from promotional activity.

Automated Replenishment: Automated Replenishment module 115 provides the retailer with the ability to manage replenishment both at the distribution center and the store levels. The module provides suggested order quantities based on business policies, service levels, forecast error, risk stock, review times, and lead times.

Time Phased Replenishment: Time Phased Replenishment module 116 Provides a weekly long-range order forecast that can be shared with vendors to facilitate collaborative planning and order execution. Logistical and ordering constraints such as lead times, review times, service-level targets, min/max shelf levels, etc. can be simulated to improve the synchronization of ordering with individual store requirements.

Allocation: The Allocation module 115 uses intelligent forecasting methods to manage pre-allocation, purchase order and distribution center on-hand allocation.

Load Builder: Load Builder module 118 optimizes the inventory deliveries coming from the distribution centers (DCs) and going to the retailer's stores. It enables the retailer to review and optimize planned loads.

Capacity Planning: Capacity Planning module 119 looks at the available throughput of a retailer's supply chain to identify when available capacity will be exceeded.

The Teradata Demand Chain Management suite of products described above models historical sales data to forecast future demand of products. Generating responsive demand forecasts depends upon the accurate calculation of Seasonal Profiles and Average Rate of Sale (ARS) for retail products. Teradata DCM utilizes six separate models to calculate ARS weekly at the product/location level. The six algorithms include 3-week, 6-week, 12-week, 26-week and 52-week adaptive models, plus a 52-week model with exponential smoothing. Once the ARS calculations are complete, the DCM application chooses the appropriate model for the next forecasting period, based on the lowest Average Forecast Error (AFE). Store forecasts can thereafter be used to order the appropriate amounts of products from warehouse or Distribution Centers (DC) to meet customer demand.

However, not all products have a demand pattern that can be reliably modeled with time series forecasting methods. Products with intermittent demand, such as wallpaper and candle holders, characteristically have a large number of zero sales periods with an occasional sales period exhibiting sales activity. Often, the demand values, when they occur, are in multiples of two, four, or ten, etc. Accordingly, an improved method for forecasting and modeling product sales for slow moving products is desired.

### BRIEF DESCRIPTION OF THE DRAWINGS

FIG. 1 provides an illustration of a forecasting, planning and replenishment software application suite for the retail industries built upon NCR Corporation's Teradata Data Warehouse.

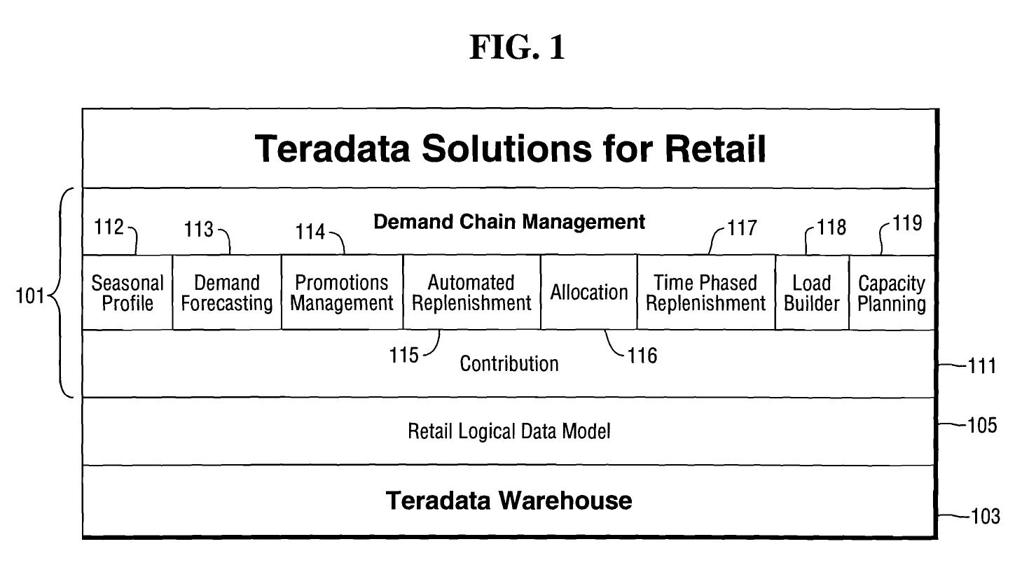

FIG. 2 provides a graph illustrating the sales activity of a slow moving product (SMP) through fifteen sales periods

FIG. 3 provides a graph showing a comparison of forecast results determined using Average Rate of Sale with Exponential Smoothing and forecast results determined utilizing Generalized Autoregressive Conditional Heteroskedasticity (GARCH) in accordance with the method of the present invention.

FIG. 4 is a table illustrating a process for determining alpha and beta parameters for use in GARCH forecast determinations.

FIG. 5 is a three-dimensional graph illustrating the process for determining alpha and beta parameters for use in GARCH forecast determinations.

FIG. 6 is a flow chart illustrating the method for estimating demand forecasts for a slow moving product in accordance with the present invention.

### DETAILED DESCRIPTION OF THE INVENTION

In the following description, reference is made to the accompanying drawings that form a part hereof, and in which is shown by way of illustration specific embodiments in which the invention may be practiced. These embodiments are described in sufficient detail to enable one of ordinary skill in the art to practice the invention, and it is to be understood that other embodiments may be utilized and that structural, logical, optical, and electrical changes may be made without departing from the scope of the present invention. The following description is, therefore, not to be taken in a limited sense, and the scope of the present invention is defined by the appended claims.

As stated earlier, the Teradata DCM application models historical sales data to forecast future demand of products. The DCM application calculates then uses Seasonal Profiles and Average Rate of Sale (ARS) to determine future demand forecasts for retail products. However, products that have low and infrequent demand are difficult to reliably model with time series forecasting methods. With slow moving products, weeks of infrequent sales and zero demands, and weeks of poor sales, result in the inability to accurately forecast the amount of merchandise required to maintain an efficient flow of products without backlogging capital. This will hinder the ability to recuperate the initial investment in a reasonable time frame and limit potential revenues.

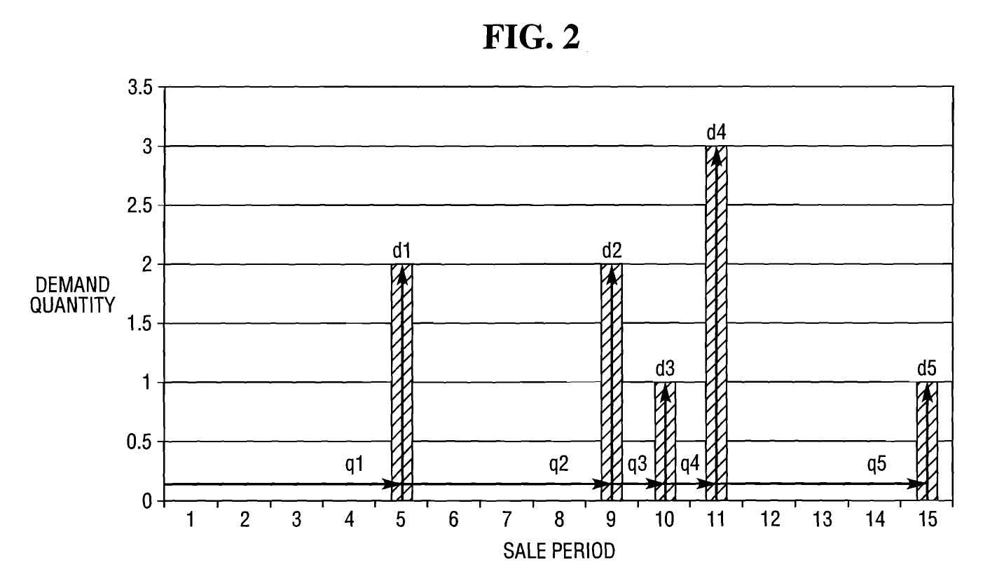

The histogram graph shown in FIG. 2 illustrates the sales activity of a slow moving product (SMP) through fifteen sales periods. The horizontal axis of the graph displays sales periods 1 through 15, which may be weeks or months. Sales quantities are measures against the vertical axis. Product sales activity is represented by the vertical bars at sales periods 5, 9, 10, 11 and 15. Sales quantities, or demand, at these periods are identified by reference numerals d1, d2, d3, d4 and d5, respectively. The intervals between successive non-zero sales periods are identified by reference numerals q1, q2, q3, q4 and q5. In the illustration, product sales quantities are zero during sales period 1-4, 6-8, and 12-14. Sales quantities during the remaining sales periods range from one unit during periods 10 and 15 to three units during period 11.

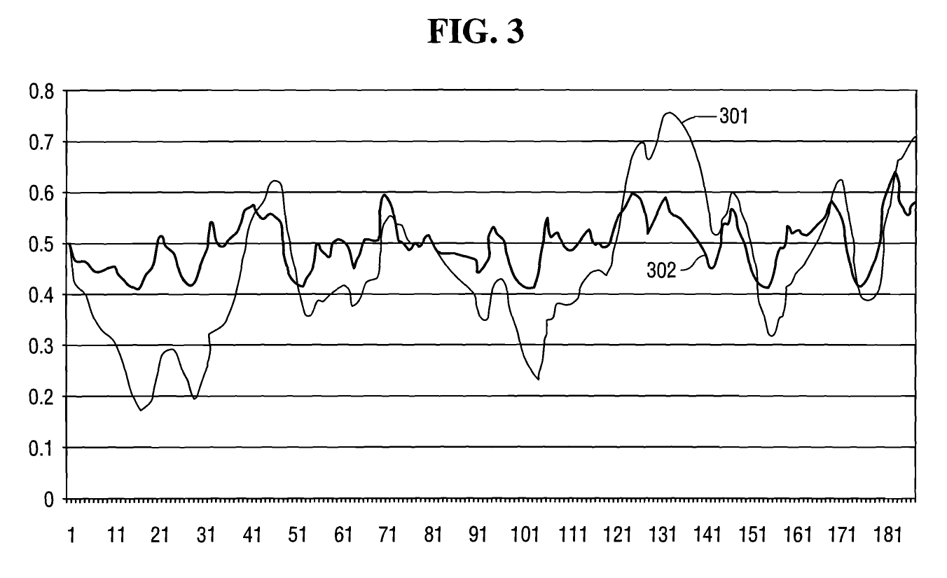

Teradata DCM currently employs a standard seasonal forecast framework, where historical product demand is are used to calculate exponential moving averages. The model calculates smoothed trends (i.e. deseasonalized forecasts) also known as Average Rate of Sales (ARS), to smooth the trend line and model the seasonalized pattern of sales. When the standard ARS calculation is applied to SMP sales patterns a forecast pattern such as the forecast represented by graph line 301 in FIG. 3 results.

The graph shown in FIG. 3 provides a comparison of forecast results determined using Average Rate of Sale with exponential smoothing, represented by graph line 301, and forecast results determined utilizing Generalized Autoregressive Conditional Heteroskedasticity (GARCH), described below, represented by graph line 302 in FIG. 3.

The GARCH system has the ability to adapt to random fluctuations in product demand better than the exponential moving average forecast model in various aspects. For calculating the ARS, GARCH would apply the following equation:

ARS=a(current weekly ARS)+β(previous weekly ARS)+(1-a-β)(52 week ARS);

where parameters a (alpha) and β (beta) are mined from historical data using Maximum Likelihood methods.

Optimization of GARCH parameters alpha and beta is essential to produce the most likely future forecast closest to the actual sales. The parameters are optimized from the current weekly and previous Average Rate of Sales (ARS) of the SKU. In the equation above, the GARCH parameters alpha and beta can only exist as values between 0.1 and 0.8, and the sum of alpha and beta are 0.9. Within the DCM forecasting system, the values of alpha and beta are dynamically optimized at regular intervals, e.g., weekly, and are not user defined variables.

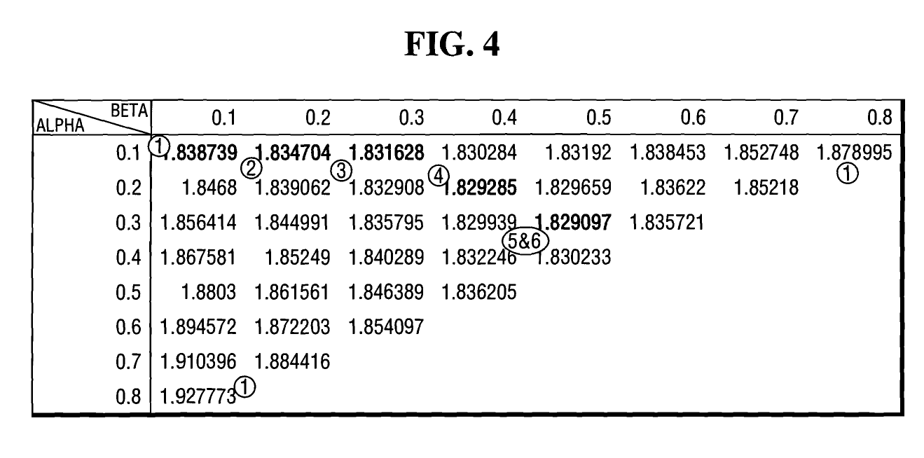

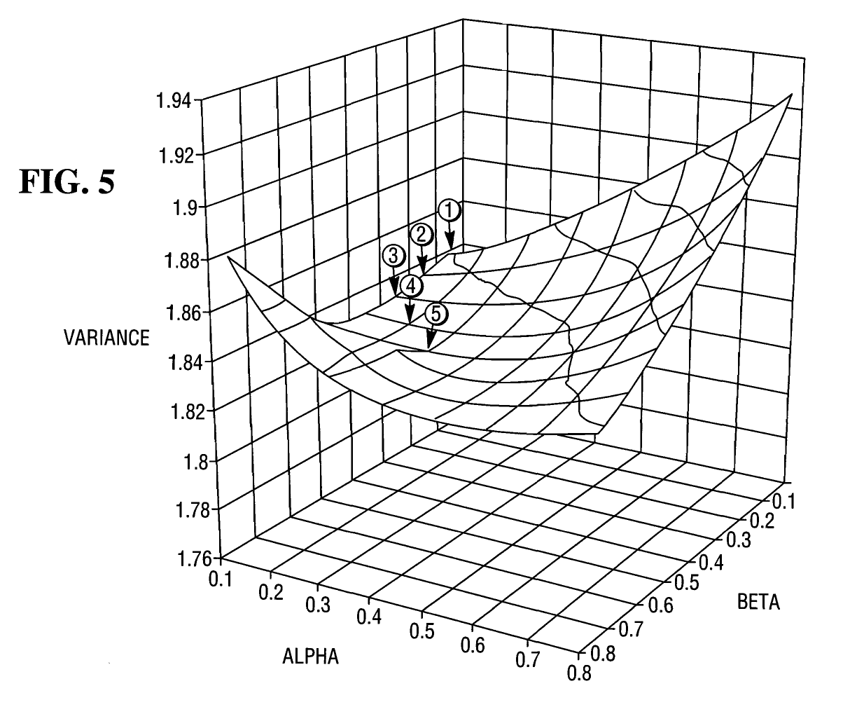

Optimization of the parameters alpha and beta can be performed via the Downhill Gradient Method, as illustrated in FIGS. 4 and 5. FIG. 4 is a table illustrating the Downhill Gradient Method for determining alpha and beta parameters for use in GARCH forecast determinations, and FIG. 5 provides a three-dimensional graph illustrating the process for determining alpha and beta parameters for use in GARCH forecast determinations.

In accordance with the Downhill Gradient Method a table with the dimensions of 7×7 is generated, with each field being populated with the variance for the combination of alpha and beta with 0.1 increments. An example of this table including variance values is shown in FIG. 4. The variance values are illustrated graphically in FIG. 5.

The corner values of the table ([0.1, 0.1], [0.1, 0.8], and [0.8, 0.1]) are populated, and the corner with the lowest variance value is selected as the origin. The corner with the lowest variance value is identified by reference numeral 1 in FIG. 4 and on the 5.

Values are entered into adjacent fields within the table, wherein the next point in the field with the lowest value is designated as the subsequent origin. This procedure is repeated until the field containing the lowest variance is the origin. These subsequent origin points are identified by reference numerals 2, 3, 4 and 5 in FIGS. 4 and 5.

This algorithm was developed by mapping the table of variance vs. alpha and beta values, in which the relatively smooth nature of the variance change became relatively noticeable, as illustrated in FIG. 5. Increments of 0.1 are utilized, as relative accuracy is not sacrificed for efficiency. Mapping the entire 7×7 region to select the minimum value improves the overall efficiency of the task and does not significantly degrade the results, due to the nature of the interaction between future variance and the alpha and beta values.

Optimization of the task is based upon the minimization of variance calculated from previous weeks given that alpha and beta are parameters. The variance is calculated as follows:

$$variance = {\sum }_{i = 1}^{n} {( {ARS}_{i} \times {sf}_{i} - {demand}_{i} )}^{2}$$

$$where n = number of weeks$$

The variance rather than MAPE (Mean Absolute Percentage Error) is used as the metric for parameter optimization since the variance encapsulates the information in both the MAPE and the bias. Optimization algorithms cannot simultaneously minimize two or more target (or objective) functions. So they cannot minimize both MAPE and bias. However, minimizing the variance has the desired effect of minimizing the bias and the MAPE, so this is typically chosen as the objective function for parameter optimization.

The number of weeks the variance calculation utilizes can vary, wherein the user can select the desired value. This value however, is restricted wherein it must be fewer than the number of weeks of functional records stored within the calculation table. The number of weeks used to calculate the current forecast during the seeding period is dependant on the number of weeks the program has previously recorded, and dictates the accuracy of predicted values utilizing the small non-normalized data available.

Referring again to FIG. 3, it is seen that the example exponential moving average forecast represented by graph line 301 has higher variation than the GARCH forecast represented by graph line 302. This is because the GARCH method has a mean reverting factor which “pulls” the forecast to the most likely long run forecast. This has the desired effect of minimizing the forecast bias and lowering the long run forecast error.

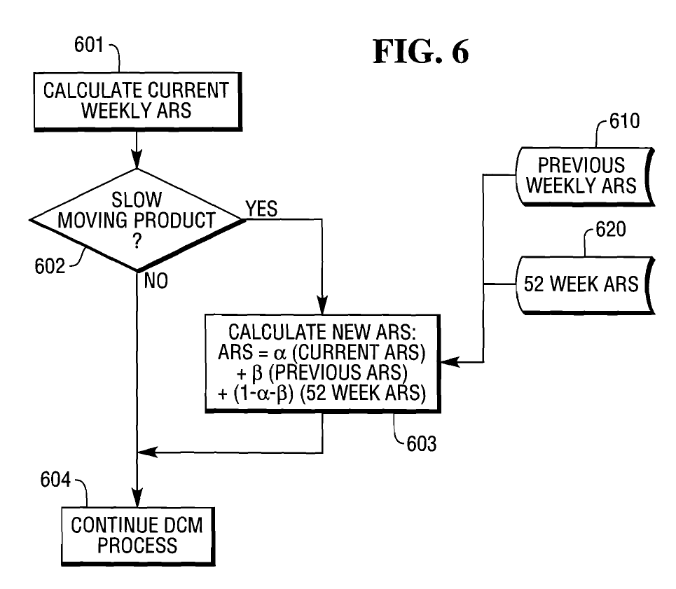

Incorporation of the above-described methodology for calculating the ARS for slow moving products into the DCM forecasting process is illustrated in the flow diagram of FIG. 6. At step 601, the current weekly ARS is calculated for SKUs in the normal manner. At step 602, slow moving products are identified. Slow movers are designated as SKUs (a) having ARS values of less than 2.0, and (b) that are not short seasonal products.

For SKUs identified as slow moving products, new ARS values are determined utilizing the equation ARS=a(current winning ARS)+β(previous ARS)+(1-a-β)(52 week ARS), as shown in step 603. The parameters a (alpha) and β (beta) are determined as explained earlier. Previous weekly ARS values and 52-week ARS values are drawn from DC historical data stores 610 and 620.

At step 620, the DCM forecasting process continues, using re-calculated ARS values from step 603 for SMP demand forecast calculations, and the current weekly ARS values from step 601 for non-SMP forecast calculation.

### CONCLUSION

The Figures and description of the invention provided above reveal a novel system and method using a mean reverting forecast method called GARCH (Generalized Autoregressive Conditional Heteroscedasticity) to accurately model the expected demand and variability of slow moving products. These improved estimates can then be used in product demand forecasts and replenishment calculations to create more accurate orders for effective inventory management. Compared to traditional forecasting methods, this solution has shown to significantly improve the overall bias for slow moving products, which will in turn reduce inventory investment, achieve higher sell through rates, and ultimately improve profitability for a retailer.

The foregoing description of various embodiments of the invention has been presented for purposes of illustration and description. It is not intended to be exhaustive or to limit the invention to the precise form disclosed. Many alternatives, modifications, and variations will be apparent to those skilled in the art in light of the above teaching. Accordingly, this invention is intended to embrace all alternatives, modifications, equivalents, and variations that fall within the spirit and broad scope of the attached claims.

What is claimed is:

1. A method for forecasting product demand for a slow moving product, the method comprising the steps of:
maintaining a database of historical product demand information;
determining at weekly intervals an current weekly average rate of sale (ARS) and a 52 week average rate of sale (ARS) for said slow moving product from said historical product demand information; and
calculating a new ARS for use in forecasting future demand for said slow moving product in accordance with the equation: new ARS=a(current weekly ARS)+β(previous weekly ARS)+(1-a-β)(52 week ARS), where parameters a (alpha) and β (beta) are mined from said historical product demand data to optimize said new ARS.

2. The method for forecasting product demand for a slow moving product in accordance with claim 1, wherein:
parameters alpha and beta exist as values between 0.1 and 0.8, and the sum of alpha and beta is 0.9.

3. The method for forecasting product demand for a slow moving product in accordance with claim 2, wherein:
the values of alpha and beta are optimized at regular intervals.

4. The method for forecasting product demand for a slow moving product in accordance with claim 3, wherein:
said regular intervals occur weekly.

5. The method for forecasting product demand for a slow moving product in accordance with claim 3, wherein:
the optimization of parameters alpha and beta is performed using a Downhill Gradient method.

6. A method for forecasting product demand for a product, the method comprising the steps of:
maintaining a database of historical product demand information;
determining at weekly intervals a current weekly average rate of sale (ARS) and a 52 week average rate of sale (ARS) for said product from said historical product demand information;
identifying said product as a slow moving product when said 52 week ARS is less than a predetermined value; and
calculating a new ARS for use in forecasting future demand for said slow moving product in accordance with the equation: new ARS=a(current weekly ARS)+β(previous weekly ARS)+(1-a-β)(52 week ARS), where parameters a (alpha) and β (beta) are mined from said historical product demand data to optimize said new ARS.

7. The method for forecasting product demand for a slow moving product in accordance with claim 6, wherein:
parameters alpha and beta exist as values between 0.1 and 0.8, and the sum of alpha and beta is 0.9.

8. The method for forecasting product demand for a slow moving product in accordance with claim 7, wherein:
the values of alpha and beta are optimized at regular intervals.

9. The method for forecasting product demand for a slow moving product in accordance with claim 8, wherein:
said regular intervals occur weekly.

10. The method for forecasting product demand for a slow moving product in accordance with claim 8, wherein:
the optimization of parameters alpha and beta is performed using a Downhill Gradient method.
